(19) United States
(12) Patent Application Publication
(10) Pub. No.: US 2026/0265142 A1
(43) Pub. Date: Sep. 10, 2026

(54) PRODUCTION OF LOW CARBON HYDRAULIC CEMENT AND CONCRETE

(71) Applicant: OTB Materials Corp., New Freedom, PA (US)

(72) Inventor: Michael A. Riley, Towson, MD (US)

(21) Appl. No.: 19/558,174

(22) Filed: Mar. 5, 2026

Related U.S. Application Data
(60) Provisional application No. 63/768,042, filed on Mar. 6, 2025.

(51) Int. Cl. C04B 28/02; C04B 18/02; C04B 22/06; C04B 28/06; C04B 103/10; C04B 103/20; C04B 111/10

(52) U.S. Cl. CPC C04B 28/021; C04B 18/02; C04B 22/064; C04B 28/06; C04B 2103/10; C04B 2103/20; C04B 2111/1025; C04B 2111/1087

(57) ABSTRACT

Environmentally sustainable hydraulic cement and concrete compositions and methods for producing low carbon footprint hydraulic cement and concrete utilizing high percentages of industrial waste materials, particularly coal fly ash, with minimal or no Portland cement content are disclosed. The hydraulic cement compositions comprise high percentages of fly ash that may include Class C fly ash or blends primarily comprising Class C fly ash combined with activators and catalysts that enable the fly ash to hydrate and develop strength without the need for Portland cement or alkali activators. The resulting cement may exhibit a very low carbon footprint measured by the amount of CO₂ per metric ton while achieving performance characteristics comparable to or exceeding those of conventional Portland cement concrete.

### CROSS-REFERENCE TO RELATED APPLICATION

This application claims the benefit of U.S. Provisional Patent Application No. 63/768,042 filed Mar. 6, 2025, which is incorporated herein by reference.

### FIELD OF THE INVENTION

The present invention relates to the production of low carbon hydraulic cement and concrete.

### BACKGROUND INFORMATION

Portland cement is the most widely used construction binding material in the world, serving as the primary ingredient in concrete for buildings, bridges, roads, and other infrastructure. However, the production of Portland cement is extremely energy-intensive and generates substantial carbon dioxide (CO₂) emissions. Specifically, the manufacture of Portland cement clinker produces approximately 900 kilograms of CO₂ per metric ton of cement, making the cement industry responsible for approximately 8% of global anthropogenic CO₂ emissions.

The CO₂ emissions from Portland cement production arise from two primary sources: (1) the calcination of limestone (CaCO₃) to produce lime (CaO), which releases CO₂ as a byproduct of the chemical reaction, and (2) the combustion of fossil fuels to heat rotary kilns to temperatures exceeding 1450° C. These inherent characteristics of Portland cement production make it challenging to significantly reduce its carbon footprint through process improvements alone.

In light of increasing global awareness of climate change and regulatory pressures to reduce greenhouse gas emissions, there is significant interest in developing alternative cement compositions that can match or exceed the performance characteristics of Portland cement while dramatically reducing CO₂ emissions. Various alternative approaches have been explored, including geopolymer cements, alkali-activated materials, and supplementary cementitious materials (SCMs).

Coal fly ash is a byproduct of coal combustion in electric power generating facilities. As coal is burned, mineral impurities in the coal (such as clay, quartz, and feldspar) are carried away by the flue gas and collected as fine particulate matter. Fly ash has pozzolanic properties and has been used as a supplementary cementitious material in Portland cement concrete for decades. The use of fly ash in concrete can improve workability, reduce permeability, increase long-term strength, and reduce the overall carbon footprint by partially replacing Portland cement.

Fly ash is generally classified into two categories based on the type of coal burned: Class F fly ash is produced from burning anthracite or bituminous coal. Class F fly ash is pozzolanic in nature, containing less than 10% calcium oxide (CaO), and requires a cementing agent such as Portland cement to react with water; Class C fly ash is produced from burning subbituminous coal or lignite. Class C fly ash contains higher amounts of calcium oxide (typically 15-40% CaO) and exhibits both pozzolanic and self-cementing properties.

While Class C fly ash has self-cementing capabilities due to its calcium content, its use in Portland cement concrete is limited by various specifications (such as ASTM C618) that impose maximum limits on calcium oxide content, sulfate content (SO₃), and loss on ignition (LOI). Many sources of Class C fly ash exceed these specified limits, particularly with respect to calcium oxide and sulfate levels, making them unsuitable for use in conventional Portland cement concrete. As a result, significant quantities of potentially useful Class C fly ash must be disposed of in landfills, representing both an environmental burden and a lost opportunity for beneficial use.

Existing alternative cement technologies, such as geopolymer cements and alkali-activated slag cements, have attempted to utilize fly ash as a constituent. However, these systems typically require the use of highly alkaline activators such as sodium hydroxide (NaOH), potassium hydroxide (KOH), or sodium silicate (Na₂SiO₃). These alkali activators present several practical challenges: they are corrosive and hazardous to handle, requiring special safety equipment and training; they are highly hygroscopic, making storage and handling difficult; they are expensive, significantly increasing material costs; their production is energy-intensive, partially offsetting the carbon savings from not using Portland cement; and they often exist in liquid or viscous form, making uniform blending with dry powders challenging.

Furthermore, many existing alternative cement systems require extensive processing of raw materials, including grinding, calcination, or other energy-intensive treatments. Some systems also require careful curing conditions (such as elevated temperature or humidity) to achieve adequate strength development, limiting their practical application in field conditions.

### SUMMARY OF THE INVENTION

The present invention provides environmentally sustainable hydraulic cement and concrete compositions and methods for producing low carbon footprint hydraulic cement and concrete utilizing high percentages of industrial waste materials, particularly coal fly ash, with minimal or no Portland cement content. The hydraulic cement compositions comprise high percentages of fly ash (particularly Class C fly ash or blends thereof) combined with specific activators and catalysts that enable the fly ash to hydrate and develop strength without the need for Portland cement or hazardous alkali activators. The resulting cement may exhibit a carbon footprint of less than 100 kg CO₂ per metric ton while achieving performance characteristics comparable to or exceeding those of conventional Portland cement concrete.

The present invention provides hydraulic cement compositions that: can utilize high percentages (greater than 50%, e.g., greater than 70%) of fly ash, including Class C fly ash that would otherwise be unsuitable for use in Portland cement concrete; achieves a dramatically reduced carbon footprint compared to Portland cement (less than 100 kg CO₂ per metric ton, compared to approximately 900 kg CO₂ per metric ton for Portland cement); does not require the use of hazardous, hygroscopic, or difficult-to-handle alkaline activators; exhibits controllable setting times and achieves high early strength development; can be produced with minimal processing and energy input; can be formulated to achieve a wide range of rheological properties, from zero-slump to self-consolidating concrete; and can be deployed in a decentralized manufacturing model to minimize transportation energy and costs.

An embodiment of the invention provides cement compositions from waste streams that may be unsuitable for use in Portland cement. The waste material may include Class C fly ash that has calcium oxide, sulfates and/or LOI levels in excess of specified maximum levels. As a result, the present cement compositions may be used to prevent such coal ash materials from being landfilled and maximize waste disposal costs.

Another embodiment of the invention provides a hydraulic cement with a high content of fly ash without the need for ordinary Portland cement. The generation of CO₂ may be minimized as a waste gas from the production of Portland cement clinker, which generates ~900 kg of CO₂ per metric ton of Portland cement manufactured. Through the use of high percentages of fly ash, the CO₂ generation attributed to this alternative cement may be less than 100 kgs of CO₂ per metric ton of cement produced. As a result of this capability, the cement described herein offers a unique advantage over other conventional cements based on CO₂ emissions alone.

In addition to its low carbon footprint, the present hydraulic cement may produce a range of slumps (from zero to a 30 inch spread for a self-consolidating concrete). This range allows it to be used in general construction repair as well as new construction given its ability to be easily finished, but also to be pumped, placed, or cast like conventional concrete. An additional benefit lies in its ability to offer an accelerated cycle time when used in precast concrete. For precast concrete, the product has been demonstrated to place as a full SCC concrete, yet still set and be able to be removed from a casting mold in as little as 90 minutes. To accomplish this, the product will have reached a minimum compressive strength of 800 psi in the period of time. This capability affords a precaster to cycle their production molds as much as 3 times per day instead of the current typical one time per day.

An aspect of the present invention is to provide a hydraulic cement composition comprising from 50 to 99 weight percent fly ash comprising at least 50 weight percent Class C fly ash, from 0.1 to 40 weight percent of an activator comprising calcium sulfoaluminate cement, calcium aluminate cement, ground granulated blast furnace slag, anhydrite, ye′elimite, or a combination thereof, and from 0.05 to 20 weight percent of a catalyst comprising calcium oxide, lime kiln dust, dolomitic lime, calcium hydroxide, or a combination thereof.

Another aspect of the present invention is to provide a curable concrete composition comprising the hydraulic cement composition described above, aggregate, and water.

A further aspect of the present invention is to provide a composition comprising an activator and catalyst for use in hydraulic cement. The composition comprises from 10 to 90 weight percent of an activator comprising calcium sulfoaluminate cement, calcium aluminate cement, ground granulated blast furnace slag, anhydrite, ye′elimite, or a combination thereof, and from 5 to 80 weight percent of a catalyst comprising calcium oxide, lime kiln dust, dolomitic lime, calcium hydroxide, or a combination thereof, wherein the composition is substantially free of Portland cement, alkali metal hydroxides, and alkali metal silicates.

Another aspect of the present invention is to provide a method of producing a low carbon hydraulic cement comprising fly ash comprising at least 50 weight percent Class C fly ash, an activator comprising calcium sulfoaluminate cement, calcium aluminate cement, ground granulated blast furnace slag, anhydrite, ye′elimite or a combination thereof, and a catalyst comprising calcium oxide, lime kiln dust, dolomitic lime, calcium hydroxide or a combination thereof, blending the fly ash, activator, and catalyst to form a dry hydraulic cement composition, wherein the dry hydraulic cement is substantially free of Portland cement clinker, alkali metal hydroxides, and alkali metal silicates.

A further aspect of the present invention is to provide a method of producing concrete with an accelerated production cycle. The method comprises mixing a hydraulic cement composition described above with aggregate and water to form a concrete mixture, placing the concrete mixture in a mold or form, allowing the concrete to set and cure to a compressive strength of at least 800 psi, and removing the concrete from the mold or form, wherein steps above are completed in 120 minutes or less from the time of initial mixing.

Another aspect of the present invention is to provide a hardened cement paste produced by hydration of the hydraulic cement composition described above, wherein the hardened cement paste comprises a microstructure comprising a continuous matrix of calcium silicate hydrate (C-S-H) gel with dispersed ettringite crystals.

These and other aspects of the present invention will be more apparent from the following description.

### DETAILED DESCRIPTION

The present invention will now be described more fully hereinafter with reference to specific embodiments. However, the invention may be embodied in many different forms and should not be construed as limited to the embodiments set forth herein. Rather, these embodiments are provided so that this disclosure will be thorough and complete, and will fully convey the scope of the invention to those skilled in the art.

As used herein, the following terms have the meanings indicated:

“Fly ash” refers to the fine particulate residue produced from the combustion of coal in electric power generating facilities, collected from the flue gases by electrostatic precipitators or bag filters.

“Class C fly ash” refers to fly ash produced from subbituminous coal or lignite, typically containing more than 10% calcium oxide (CaO) and exhibiting both pozzolanic and self-cementing properties.

“Class F fly ash” refers to fly ash produced from anthracite or bituminous coal, typically containing less than 10% calcium oxide and exhibiting primarily pozzolanic properties.

“Class N fly ash” refers to fly ash produced from sources other than coal, or pozzolanic materials of similar composition.

“Hydraulic cement” refers to a cement that sets and hardens by chemical reaction with water and is capable of doing so underwater.

“Activator” refers to a material that initiates or accelerates the pozzolanic reaction of fly ash, enabling it to hydrate and develop strength.

“Catalyst” refers to a material that accelerates the hydration reactions without being consumed, or that provides a chemical environment conducive to hydration (such as by providing hydroxyl ions).

“CSA cement” or “calcium sulfoaluminate cement” refers to a hydraulic cement characterized by high content of ye′elimite (Ca₄Al₆SO₁₆) and typically containing varying amounts of belite, gypsum, and/or anhydrite.

“Quicklime” refers to calcium oxide (CaO), typically produced by thermal decomposition of limestone or lime-rich materials.

“Ettringite” refers to a hydrated calcium aluminum sulfate mineral with the formula Ca₆Al₂ (SO₄)₃ (OH)₁₂·26H₂O.

“C-S-H” or “calcium silicate hydrate” refers to the gel-like product of the hydration of Portland cement or other calcium silicate-containing materials, having a variable composition generally represented as CₓSₓH_{y}.

“Compressive strength” refers to the measured resistance of a concrete or mortar specimen to axial loading, typically expressed in pounds per square inch (psi) or megapascals (MPa), as determined according to ASTM C39 or equivalent standards.

“Set time” refers to the time required for a cement paste, mortar, or concrete to reach a defined consistency, as measured by penetration resistance or other standard methods (e.g., ASTM C403).

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention. As used herein, “consisting of” is understood in the context of this application to exclude the presence of any unspecified element, material, phase or method step.

“Substantially free” means that a particular element or material is not purposefully added to the composition, and is only present as an impurity or in trace amounts (less than 0.1 weight percent).

The present hydraulic cement compositions may comprise the following in combination: (i) fly ash as the predominant constituent at 50-99 weight percent, particularly Class C fly ash with elevated CaO, SO₃, and/or LOI that would disqualify it under ASTM C618; (ii) a dry, non-alkaline inorganic activator system based on calcium sulfoaluminate cement at 1-15 weight percent; (iii) a dry calcium oxide catalyst at 0.05-20 weight percent providing in-situ alkalinity; (iv) absence of Portland cement clinker; and (v) absence of alkali metal hydroxides, alkali metal silicates, and organic acid salt activators. The combination of these elements yields a cement composition that achieves a carbon footprint below 100 kg CO₂ per metric ton, rapid early strength development without elevated curing temperatures, a distinctive ettringite-reinforced C-S-H microstructure, and practical deployment using only commercially established dry powder materials and conventional concrete batch plant equipment—a set of distinctions not found in the prior art either individually or in combination.

The invention provides a hydraulic cement composition comprising: (a) from 50 to 99 weight percent fly ash; (b) from 0.1 to 40 weight percent of an activator selected from the group consisting of calcium sulfoaluminate cement, calcium aluminate cement, ground granulated blast furnace slag, and combinations thereof; (c) from 0.05 to 20 weight percent of a catalyst comprising calcium oxide or a calcium oxide precursor; and optionally (d) from 0.005 to 2 weight percent of a retarder; and/or (e) from 0.01 to 10 weight percent of a densifier.

In certain embodiments, the fly ash comprises Class C fly ash, or a blend of Class C fly ash with Class F fly ash and/or Class N fly ash. The fly ash may have a calcium oxide content of from 15 to 40 weight percent, a sulfate content (as SO₃) of from 1 to 10 weight percent, and/or a loss on ignition of from 1 to 15 weight percent.

In particular embodiments, the activator comprises calcium sulfoaluminate (CSA) cement present at from 1 to 15 weight percent of the total cement composition, more preferably from 2 to 10 weight percent, and most preferably from 3 to 8 weight percent. The catalyst comprises quicklime (CaO) or lime kiln dust present at from 0.5 to 10 weight percent, more preferably from 1 to 6 weight percent, and most preferably from 2 to 4 weight percent.

The retarder, when used, may comprise citric acid or a salt thereof, boric acid or a salt thereof, calcium sulfate (including gypsum, hemihydrate, or anhydrite), or combinations thereof. The densifier, when used, may comprise silica fume, metakaolin, lithium silicate, sodium silicate, colloidal silica, or combinations thereof.

In another aspect, the invention provides a concrete composition comprising: (a) from 5 to 60 weight percent of the hydraulic cement composition described above (calculated on a dry weight basis after curing); (b) from 30 to 80 weight percent aggregate; and (c) from 5 to 25 weight percent water.

In yet another aspect, the invention provides a method of producing a low carbon hydraulic cement comprising: (a) providing fly ash comprising at least 50 weight percent Class C fly ash; (b) blending the fly ash with from 0.1 to 40 weight percent of an activator and from 0.05 to 20 weight percent of a catalyst to form a dry cement blend; and (c) optionally adding retarders and/or densifiers. The method is characterized in that no Portland cement clinker or hydraulic alkali activator is required.

In still another aspect, the invention provides a method of producing concrete with an accelerated production cycle, comprising: (a) mixing the hydraulic cement composition with aggregate and water to form a concrete mixture having a slump flow of at least 24 inches; (b) placing or casting the concrete mixture; (c) allowing the concrete to set and cure to a compressive strength of at least 800 psi; and (d) removing formwork or demolding the concrete, wherein steps (b) through (d) are completed in 90 minutes or less from the time of initial mixing.

The invention advantageously provides a crystalline microstructure comprising calcium silicate hydrate (C-S-H) gel as a continuous matrix with dispersed ettringite crystals. The ettringite crystals act as reinforcing elements within the C-S-H matrix, contributing to early strength development and long-term durability.

The invention further provides a decentralized manufacturing and distribution system wherein: (a) bulk fly ash (e.g., constituting 75-95% of the final cement) is shipped directly from power plants or fly ash depots to end users; and (b) a concentrated activator/catalyst blend (e.g., constituting 5-25% of the final cement) is produced at regional facilities and shipped to end users, where the two components are combined at the point of use. This decentralized approach minimizes energy consumption for blending, reduces transportation costs and associated carbon emissions, and allows for greater flexibility in formulation to accommodate variations in local fly ash characteristics.

### Fly Ash

The hydraulic cement compositions of the present invention comprise fly ash as the predominant constituent. The fly ash may typically comprise at least 50 weight percent of the hydraulic cement composition, for example, at least 60 weight percent, or at least 70 weight percent, or at least 75 weight percent, or at least 80 weight percent, or at least 85 weight percent. The fly ash may comprise up to 99 weight percent, or up to 98 weight percent, or up to 97 weight percent, or up to 96 weight percent, or up to 95 weight percent, or up to 94 weight percent. The fly ash may typically comprise from 50 to 99 weight percent, or from 60 to 98 weight percent, or from 70 to 97 weight percent, or from 75 to 96 weight percent, or from 80 to 95 weight percent, or from 85 to 94 weight percent, based on the total weight of the dry cement composition (prior to addition of water and aggregates).

The ash component of the present concrete materials (after the addition of aggregates and water and curing) may be greater than 5 weight percent, for example, greater than 10 weight percent, or greater than 15 weight percent, or greater than 20 weight percent. The fly ash may be less than 60 weight percent, for example, less than 50 weight percent, or less than 40 weight percent, or less than 30 weight percent, or less than 25 weight percent. The amount of fly ash may range from 5 to 60 weight percent, for example, from 10 to 50 weight percent, or from 15 to 40 weight percent, or from 18 to 30 weight percent.

The fly ash may comprise Class C fly ash, Class F fly ash, Class N fly ash, or any combination thereof. In certain embodiments, the fly ash comprises at least 50 weight percent Class C fly ash, more preferably at least 70 weight percent Class C fly ash, still more preferably at least 85 weight percent Class C fly ash, and most preferably at least 95 weight percent Class C fly ash, based on the total weight of fly ash in the composition.

Blends of Class C fly ash with Class F fly ash may be used to optimize reactivity, setting time, and final strength properties. In such blends, the weight ratio of Class C fly ash to Class F fly ash may typically range from 99:1 to 50:50, for example, from 95:5 to 60:40, or from 90:10 to 70:30.

The Class C fly ash used in the present invention may have characteristics that would render it unsuitable for use in conventional Portland cement concrete under existing specifications (such as ASTM C618). Specifically, the Class C fly ash may have:
(a) A calcium oxide (CaO) content of from 15 to 40 weight percent, or from 18 to 35 weight percent, or from 20 to 32 weight percent;
(b) A sulfate content (measured as SO₃) of from 1 to 10 weight percent, or from 2 to 8 weight percent, or from 3 to 7 weight percent;
(c) A loss on ignition (LOI) of from 0.5 to 15 weight percent, or from 1 to 10 weight percent, or from 2 to 8 weight percent;
(d) A silica (SiO₂) content of from 25 to 50 weight percent, or from 30 to 45 weight percent;
(e) An alumina (Al₂O₃) content of from 10 to 30 weight percent, or from 15 to 25 weight percent; and/or
(f) An iron oxide (Fe₂O₃) content of from 3 to 20 weight percent, or from 5 to 15 weight percent.

The particle size distribution of the fly ash may vary depending on the source and collection method. Typically, the fly ash has a median particle size (d₅₀) of from 5 to 50 micrometers, for example, from 10 to 30 micrometers. The fly ash may have a Blaine fineness of at least 2500 cm²/g, or at least 3000 cm²/g.

An advantage of the present invention is its ability to utilize fly ash from various sources without requiring extensive beneficiation or processing. Fly ash that would otherwise require disposal in landfills due to high calcium, sulfate, or LOI content can be effectively utilized in the present cement compositions, thereby providing both economic and environmental benefits.

### Activators

The cement compositions of the present invention include one or more activators that initiate or accelerate the hydration of the fly ash. The activator may typically comprise at least 0.1 weight percent, for example, at least 0.2 weight percent, or at least 0.5 weight percent, or at least 1 weight percent, or at least 2 weight percent, or at least 3 weight percent. The activator may typically comprise up to 40 weight percent, for example, up to 30 weight percent, or up to 20 weight percent, or up to 15 weight percent, or up to 12 weight percent, or up to 10 weight percent. The activator may typically comprise from 0.1 to 40 weight percent, for example, from 0.2 to 30 weight percent, or from 0.5 to 20 weight percent, or from 1 to 15 weight percent, or from 2 to 12 weight percent, or from 3 to 10 weight percent, based on the total weight of the dry cement composition.

Suitable activators include, but are not limited to:
(a) Calcium sulfoaluminate (CSA) cement;
(b) Calcium aluminate cement;
(c) Ground granulated blast furnace slag (GGBFS);
(d) Anhydrite (CaSO₄);
(e) Ye′elimite (Ca₄Al₆SO₁₆); and
(f) Combinations of any of the foregoing.

In certain embodiments, the activator comprises calcium sulfoaluminate (CSA) cement. CSA cement is characterized by a high content of ye′elimite (Ca₄Al₆SO₁₆), which is the primary hydraulic phase. CSA cement may further comprise belite (Ca₂SiO₄), gypsum (CaSO₄: 2H₂O), anhydrite (CaSO₄), and/or other minor phases.

When CSA cement is used as the activator, it may typically be present in an amount of from 1 to 15 weight percent, for example, from 2 to 12 weight percent, or from 3 to 10 weight percent, or from 4 to 8 weight percent, based on the total weight of the dry cement composition. Within these ranges, the CSA cement provides sufficient activation of the fly ash to achieve rapid setting and early strength development, while maintaining a low overall cost and carbon footprint.

Ground granulated blast furnace slag (GGBFS) may be used as an activator, either alone or in combination with CSA cement. GGBFS is a byproduct of iron production and consists primarily of calcium silicates and calcium aluminosilicates. GGBFS may typically comprise at least 2 weight percent, for example, at least 5 weight percent, or at least 10 weight percent. GGBFS may typically comprise up to 30 weight percent, for example, up to 25 weight percent, or up to 20 weight percent. When used as an activator, GGBFS may typically comprise from 2 to 30 weight percent, for example, from 5 to 25 weight percent, or from 10 to 20 weight percent.

The activators of the present invention are distinguished from the alkali activators used in conventional geopolymer or alkali-activated slag systems. Notably, the present cement compositions do not require the use of sodium hydroxide (NaOH), potassium hydroxide (KOH), sodium silicate (Na₂SiO₃), or other highly alkaline or corrosive compounds. This represents a significant practical advantage, as these alkali activators are hazardous to handle, hygroscopic, expensive, and energy-intensive to produce.

### Catalysts

The cement compositions of the present invention include one or more catalysts that accelerate the hydration reactions and/or provide a chemical environment conducive to hydration. The catalyst may typically comprise at least 0.05 weight percent, for example, at least 0.1 weight percent, or at least 0.3 weight percent, or at least 0.5 weight percent, or at least 1 weight percent, or at least 2 weight percent. The catalyst may typically comprise up to 20 weight percent, for example, up to 15 weight percent, or up to 10 weight percent, or up to 8 weight percent, or up to 6 weight percent, or up to 4 weight percent. The catalyst may typically comprise from 0.05 to 20 weight percent, for example, from 0.1 to 15 weight percent, or from 0.3 to 10 weight percent, or from 0.5 to 8 weight percent, or from 1 to 6 weight percent, or from 2 to 4 weight percent, based on the total weight of the dry cement composition.

Suitable catalysts include, but are not limited to:
(a) Calcium oxide (CaO), also known as quicklime;
(b) Lime kiln dust;
(c) Dolomitic lime;
(d) Calcium hydroxide (Ca(OH) 2), also known as hydrated lime or slaked lime; and
(e) Combinations of any of the foregoing.

In certain embodiments, the catalyst comprises calcium oxide (quicklime). When mixed with water, calcium oxide rapidly hydrates to form calcium hydroxide (Ca(OH) 2), releasing heat and generating a highly alkaline environment (pH greater than 12). This alkaline environment activates the pozzolanic reactions of the fly ash, causing dissolution of silica and alumina from the fly ash particles and subsequent precipitation of calcium silicate hydrate (C-S-H) and calcium aluminate hydrate phases.

The in-situ generation of calcium hydroxide from calcium oxide offers several advantages: calcium oxide is less expensive than pre-hydrated calcium hydroxide; calcium oxide is not hygroscopic and is therefore easier to handle and store; calcium oxide can be blended with other dry powder components without special handling; the heat of hydration from the conversion of CaO to Ca(OH) 2 can be beneficial for low-temperature applications; and the timing of alkalinity development can be controlled by the rate at which water is added.

Lime kiln dust, a byproduct of lime manufacturing, may also be used as a catalyst. Lime kiln dust typically contains calcium oxide, calcium hydroxide, calcium carbonate, and other minor constituents. The lime kiln dust may typically comprise at least 1 weight percent, for example, at least 2 weight percent. The lime kiln dust may typically comprise up to 10 weight percent, for example, up to 8 weight percent. When lime kiln dust is used, it may typically comprise from 1 to 10 weight percent, or from 2 to 8 weight percent.

Activators and catalysts as described above may be mixed together, e.g., prior to mixing or blending with the fly ash component. For example, such an activator/catalyst composition may comprise from 10 to 90 weight percent, or from 20 to 80 weight percent, of an activator comprising calcium sulfoaluminate cement, calcium aluminate cement, ground granulated blast furnace slag, anhydrite, ye′elimite, or a combination thereof, and from 5 to 80 weight percent, or from 10 to 60 weight percent, of a catalyst comprising calcium oxide, lime kiln dust, dolomitic lime, calcium hydroxide, or a combination thereof. The composition may be substantially free of Portland cement, alkali metal hydroxides, and alkali metal silicates.

### Retarders

The cement compositions of the present invention may optionally include one or more retarders to control the rate of hydration and extend the working time (pot life) of the fresh concrete or mortar. When used, the retarder may typically comprise at least 0.005 weight percent, for example, at least 0.01 weight percent, or at least 0.02 weight percent, or at least 0.05 weight percent. The retarder may typically comprise up to 2 weight percent, for example, up to 1 weight percent, or up to 0.5 weight percent, or up to 0.2 weight percent. When present, the retarder may typically comprise from 0.005 to 2 weight percent, for example, from 0.01 to 1 weight percent, or from 0.02 to 0.5 weight percent, or from 0.05 to 0.2 weight percent, based on the total weight of the dry cement composition.

Suitable retarders include, but are not limited to:
(a) Citric acid and salts thereof (e.g., sodium citrate, potassium citrate, calcium citrate);
(b) Boric acid and salts thereof (e.g., sodium borate);
(c) Tartaric acid and salts thereof;
(d) Gluconic acid and salts thereof (e.g., sodium gluconate);
(e) Phosphoric acid and salts thereof;
(f) Calcium sulfate in various forms (gypsum, hemihydrate, anhydrite);
(g) Lignosulfonates;
(h) Hydroxycarboxylic acids and their salts; and
(i) Combinations of any of the foregoing.

In certain embodiments, the retarder comprises citric acid or a salt thereof, boric acid or a salt thereof, or a combination thereof. These materials are effective at retarding the hydration reactions of both the CSA cement activator and the fly ash, thereby extending the working time and allowing for placement of the concrete.

Calcium sulfate (in the form of gypsum, hemihydrate, or anhydrite) may also function as a retarder by controlling the formation of ettringite. When calcium sulfate is used as a retarder, it is typically present in an amount of from 0.5 to 5 weight percent, for example, from 1 to 3 weight percent.

The selection and amount of retarder may be adjusted based on the desired setting time, ambient temperature, and specific application requirements. For example, in hot weather conditions or for applications requiring extended working time, higher amounts of retarder may be used. Conversely, for rapid-setting applications or cold weather conditions, the retarder may be reduced or omitted entirely.

### Densifiers

The cement compositions of the present invention may optionally include one or more densifiers to improve the packing density of the hydrated cement paste, reduce porosity, and enhance durability. When present, the densifier is included in a typical amount of from 0.01 to 10 weight percent, for example, from 0.05 to 5 weight percent, or from 0.1 to 2 weight percent, or from 0.3 to 1 weight percent, based on the total weight of the dry cement composition.

Suitable densifiers include, but are not limited to:
(a) Silica fume (microsilica);
(b) Metakaolin;
(c) Ultrafine fly ash;
(d) Nano-silica;
(e) Colloidal silica;
(f) Lithium silicate;
(g) Sodium silicate (in limited amounts); and
(h) Combinations of any of the foregoing.

Silica fume is a byproduct of the production of silicon and ferrosilicon alloys and consists of very fine spherical particles of amorphous silica dioxide (SiO₂). The particle size of silica fume is typically 0.1 to 0.3 micrometers, which is approximately 100 times finer than cement particles. Due to its extreme fineness and high silica content, silica fume is highly reactive and fills the voids between larger particles, resulting in a denser microstructure.

Metakaolin is a dehydroxylated form of the clay mineral kaolinite, produced by calcination at temperatures of 650-900° C. Metakaolin is highly pozzolanic and reacts with calcium hydroxide to form additional C-S-H gel. The metakaolin may typically comprise at least 0.5 weight percent, for example, at least 1 weight percent. The metakaolin may typically comprise up to 5 weight percent, for example, up to 3 weight percent. When used as a densifier, metakaolin may typically comprise from 0.5 to 5 weight percent, more preferably from 1 to 3 weight percent.

The densifier serves multiple functions: (a) it fills the interstitial spaces between larger particles through a physical packing effect; (b) it provides additional pozzolanic reactivity, consuming calcium hydroxide and forming additional binding phases; and (c) it refines the pore structure, reducing permeability and improving resistance to chemical attack.

### Additional Additives

The cement and concrete compositions of the present invention may optionally include other additives commonly used in concrete technology, including but not limited to:
(a) Water-reducing admixtures (plasticizers) and high-range water reducers (superplasticizers);
(b) Air-entraining agents;
(c) Accelerators;
(d) Defoamers or anti-foaming agents;
(e) Viscosity-modifying agents;
(f) Shrinkage-reducing admixtures;
(g) Corrosion inhibitors;
(h) Pigments or colorants;
(i) Internal curing agents;
(j) Internal sealants or waterproofing agents;
(k) Fibers (synthetic, steel, glass, or natural); and
(l) Combinations of any of the foregoing.

These additional additives may be used in amounts ranging from 0.01 to 5 weight percent, based on the total weight of the cement composition, and may be selected and proportioned according to the specific performance requirements of the application.

### Concrete Compositions

The present invention further provides concrete compositions comprising the hydraulic cement described above combined with aggregates and water. The cement composition may typically comprise at least 5 weight percent, for example, at least 10 weight percent, or at least 15 weight percent, or at least 18 weight percent. The cement composition may typically comprise up to 60 weight percent, for example, up to 50 weight percent, or up to 40 weight percent, or up to 30 weight percent. In the cured concrete (calculated on a dry weight basis after hardening), the cement composition may typically comprise from 5 to 60 weight percent, for example, from 10 to 50 weight percent, or from 15 to 40 weight percent, or from 18 to 30 weight percent.

Aggregates suitable for use in the present concrete compositions include, but are not limited to:
(a) Natural sand and gravel;
(b) Crushed stone (limestone, granite, basalt, etc.);
(c) Lightweight aggregates (expanded clay, shale, slate, perlite,
vermiculite);
(d) Recycled concrete aggregate;
(e) Glass cullet;
(f) Manufactured aggregates; and
(g) Combinations of any of the foregoing.

The aggregate may typically comprise at least 30 weight percent or the cured concrete, for example, at least 40 weight percent, or at least 50 weight percent. The aggregate may typically comprise up to 80 weight percent, for example, up to 75 weight percent, or up to 70 weight percent. The aggregate may typically comprise from 30 to 80 weight percent of the cured concrete, for example, from 40 to 75 weight percent, or from 50 to 70 weight percent. The aggregate may comprise fine aggregate (sand passing through a No. 4 sieve, 4.75 mm), coarse aggregate (retained on a No. 4 sieve), or a combination thereof.

Water may be added to the cement and aggregate mixture in an amount sufficient to hydrate the cement and provide the desired consistency and workability. The water-to-cement ratio (by weight) is typically less than 0.60, for example, less than 0.50, or less than 0.40, or less than 0.35. The water-to-cement ratio may typically be greater than 0.05, for example, greater than 0.10, or greater than 0.15, or greater than 0.20. The water-to-cement ratio may typically range from 0.05 to 0.60, for example, from 0.10 to 0.50, or from 0.15 to 0.40, or from 0.20 to 0.35.

In the fresh concrete mixture (before curing), water is typically present in an amount of from 5 to 25 weight percent, for example, from 8 to 20 weight percent, or from 10 to 18 weight percent, based on the total weight of the fresh concrete.

### Hydration Chemistry and Microstructure

Upon mixing with water, the cement compositions of the present invention undergo a complex series of hydration reactions that result in the formation of a hardened, load-bearing material. The hydration reactions involve interactions between the fly ash, the activator (e.g., CSA cement), the catalyst (e.g., calcium oxide), and water.

When calcium oxide (quicklime) is added to water, it rapidly hydrates according to the following exothermic reaction:

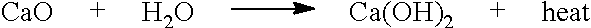

This reaction generates calcium hydroxide and raises the pH of the pore solution to approximately 12.5-13. The high pH environment causes partial dissolution of the glassy aluminosilicate phases in the fly ash, releasing silica, alumina, and calcium into solution.

Simultaneously, the CSA cement activator begins to hydrate. The primary clinker phase in CSA cement, ye′elimite (Ca₄Al₆SO₁₆), reacts with water and calcium sulfate (if present) to form ettringite:

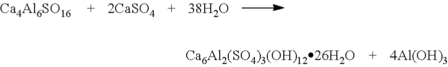

or, in the absence of additional sulfate:

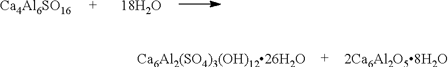

Ettringite is a needle-shaped or prismatic crystal that forms rapidly and contributes to early strength development. The formation of ettringite provides dimensional stability and creates a skeletal structure within the cement paste.

The dissolved silica from the fly ash reacts with calcium ions (from both the calcium hydroxide and the fly ash) to form calcium silicate hydrate (C-S-H) gel:

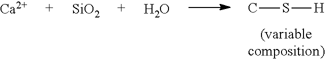

C-S-H is the primary binding phase in the hardened cement and is responsible for the long-term strength and durability. The C-S-H gel forms a continuous matrix that binds the unreacted fly ash particles, aggregates, and other phases together.

Alumina released from the fly ash may react with calcium and sulfate to form additional ettringite, or may be incorporated into calcium aluminate hydrate phases such as C₄AH₁₃ or C₃AH₆.

The resulting microstructure of the hardened cement paste may comprise a continuous matrix of C-S-H gel with dispersed ettringite crystals. The ettringite crystals act as micro-reinforcing elements, similar to fibers, providing early strength and toughness. This microstructure is particularly advantageous as it combines the long-term strength and chemical resistance of C-S-H with the rapid strength development associated with ettringite formation. The present invention achieves this beneficial microstructure without the need for Portland cement clinker and its associated high CO₂ emissions.

### Performance Characteristics

The cement and concrete compositions of the present invention exhibit a wide range of performance characteristics that can be tailored to specific applications through adjustment of formulation and mix design.

### Setting Time

The setting time of the concrete compositions may be controlled through the selection and amount of activator, catalyst, and retarder. Typical set times may range from 15 minutes to 4 hours, measured from the time of initial water addition.

For rapid-setting applications (such as emergency repairs or fast-track construction), formulations can be designed to achieve initial set in 15 to 60 minutes. For normal construction applications, initial set times of 1 to 3 hours are typical. For applications requiring extended working time (such as in hot weather or for large pours), set times can be extended to 3 to 6 hours through the use of appropriate retarders.

### Working Time (Pot Life)

The working time, or pot life, of the fresh concrete is the time during which the concrete remains sufficiently workable for placement and finishing. The working time is typically 10 to 120 minutes, more commonly 20 to 90 minutes, and can be adjusted through formulation changes.

For self-consolidating concrete (SCC) applications, working times of 30 to 90 minutes are typical, allowing sufficient time for pumping, placing, and flow into complex formwork.

### Rheology and Workability

One of the significant advantages of the present invention is the ability to formulate concrete compositions with a wide range of rheological properties, from zero-slump (dry-cast) to highly fluid self-consolidating concrete (SCC).

For zero-slump or dry-cast applications (such as concrete masonry units), the concrete is formulated with very low water content and is immediately compacted using vibration or pressure. Such formulations may have a slump of 0 to 1 inch.

For conventional concrete applications, slumps of 2 to 8 inches are typical, providing adequate workability for placement by conventional methods (wheelbarrow, bucket, chute, or truck discharge).

For self-consolidating concrete (SCC) applications, the concrete is designed to flow under its own weight without the need for mechanical vibration. SCC formulations typically exhibit slump flow values (measured using the inverted cone test according to ASTM C₁₆₁₁) of 20 to 30 inches, more preferably 24 to 28 inches.

The ability to produce SCC with rapid setting is particularly advantageous for precast concrete applications, as it enables the concrete to be easily placed and self-leveled in the mold, yet still achieve sufficient strength for demolding in a short time (typically 60 to 120 minutes).

### Compressive Strength Development

The concrete compositions of the present invention exhibit rapid early strength development, achieving usable strengths within hours of placement. The following strength ranges are typical:

### High Early-Ultrafast Set (Set Time 15-30 Minutes):

30 minutes from mixing: 1500-2500 psi
2 hours from set time: 4000-6000 psi
28 days: 10,000-15,000 psi

### Fast Set (Set Time 1-2 Hours):

2 hours from set time: 2000-4000 psi
24 hours: 5000-8000 psi
28 days: 8000-12,000 psi

### Normal Set (Set Time 2-4 Hours):

2 hours from set time: 800-1500 psi
24 hours: 2000-3500 psi
28 days: 6000-9000 psi

These strength values are comparable to or exceed those of conventional Portland cement concrete, while being achieved with dramatically lower CO₂ emissions.

Other than the ingredients specified herein for inclusion in the present cement compositions, the compositions may be substantially free of other materials. As used herein, “substantially free” means that a particular element or material is not purposefully added to the composition, and is only present as an impurity or in trace amounts. The cement compositions may consist essentially of fly ash, activators, catalysts, retarders and densifiers as described above. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

The following examples are intended to illustrate various aspects of the present invention, and are not intended to limit the scope of the invention.

### Examples

The following examples illustrate cement and concrete compositions within the scope of the present invention, along with measured working times, set times, slump/spread values, and compressive strengths at 4 hours, 24 hours, 7 days, and 28 days. All component quantities are expressed as weight percent of the total fresh concrete mixture (including aggregates and water). Fly ash as % cement is the weight percent of fly ash relative to the total cementitious fraction only (fly ash+activator+catalyst+densifier). Compressive strengths are reported in pounds per square inch (psi) as determined in accordance with ASTM C39.

Exemplary cement and concrete compositions are listed in Tables 1-3 below, along with concrete working times and compressive strengths.

TABLE 1
Compositions

| | Component | | | | | | | | | |
|---|---|---|---|---|---|---|---|---|---|---|
| | | Fly | | | | | | | | |
| | Fly | Ash as | | | | | Fine | Coarse | | |
| Sample | Ash | wt % of | Activator | Catalyst | Retarder | Densifier | Aggregate | Aggregate | Plasticizer | Water |
| No. | (wt %) | Cement | (wt %) | (wt %) | (wt %) | (wt %) | (wt %) | (wt %) | (wt %) | (wt %) |
| 1 | 22 | 89 | 1.9 | 0.34 | 0.125 | 0.5 | 39 | 39 | 0.03 | 6.2 |
| 2 | 13.9 | 84 | 1.9 | 0.8 | 0.19 | 0 | 36 | 35 | 0.03 | 6.8 |
| 3 | 22.5 | 92 | 1.53 | 0.34 | 0.12 | 0 | 37.75 | 37.75 | 0.03 | 5.4 |
| 4 | 19.9 | 85 | 2 | 0.5 | 0.05 | 1 | 39.3 | 39.3 | 0.03 | 4.9 |
| 5 | 17.9 | 83.6 | 2 | 0.5 | 0 | 1 | 39.3 | 39.3 | 0.03 | 4.8 |
| 6 | 20 | 77 | 5 | 0.85 | 0 | 0.5 | 32 | 42 | 0.06 | 7 |
| 7 | 19.5 | 85 | 2.5 | 1 | 0.07 | 0 | 38.3 | 38.3 | 0.01 | 8 |
| 8 | 17.1 | 88 | 2.19 | 0.13 | 0 | 0.88 | 39.28 | 39.28 | 0.01 | 6.9 |
| 9 | 15.29 | 86 | 1.78 | 0.65 | 0 | 0.38 | 48.6 | 33.3 | 0.01 | 4.5 |
| 10 | 21.68 | 92 | 1.48 | 0 | 0.14 | 0.33 | 37.4 | 36.5 | 0.01 | 6.3 |
| 11 | 42 | 90 | 4 | 0.63 | 0.06 | 0 | 25.4 | 27.5 | 0.01 | 6.5 |
| 12 | 20.9 | 86 | 3.3 | 0.33 | 0.08 | 0 | 37.6 | 37.6 | 0.02 | 7.74 |
| 13 | 16.6 | 87.6 | 2.2 | 0.33 | 0.13 | 0 | 47.8 | 33 | 0.015 | 5.33 |
| 14 | 14 | 81 | 2 | 1.3 | 0.15 | 0 | 37 | 46.8 | 0.01 | 6.8 |
| 15 | 25 | 80 | 6 | 5 | 0.1 | 1 | 60 | 0 | 0.02 | 7 |
| 16 | 18.87 | 94 | 0.5 | 0.8 | 0.2 | 0 | 22.7 | 36.5 | 0.01 | 5.5 |

TABLE 2
Working Time-Set Time-Slump/Spread

Component

| Sample | Working | Set Time | Slump/Spread |
|---|---|---|---|
| No | Time (min) | (min) | (inch) |
| 1 | 37 | 150 | 8.75 |
| 2 | 90 | 103 | 9.25 |
| 3 | 35 | 184 | 9 |
| 4 | 60 | 130 | 24 |
| 5 | 40 | 65 | 30 |
| 6 | 30 | 60 | 21 |
| 7 | 80 | 100 | 26 |
| 8 | 45 | 71 | 18 |
| 9 | 60 | 130 | 28 |
| 10 | 47 | 142 | 24 |
| 11 | 36 | 78 | 30 |
| 12 | 38 | 80 | 3 |
| 13 | 31 | 39 | 8.25 |
| 14 | 45 | 68 | 7 |
| 15 | 15 | 25 | 0 |
| 16 | 40 | 94 | 7.5 |

TABLE 3
Compressive Strengths (PSI)

| | |
|---|---|
| Sample | Component |

| No | 4 Hour | 24 Hour | 7 Day | 28 Day |
|---|---|---|---|---|
| 1 | 900 | 3045 | 5750 | 7880 |
| 2 | 1920 | 3100 | 5100 | 6300 |
| 3 | 1120 | 3690 | 7050 | 9250 |
| 4 | 3160 | 5380 | 8050 | 10350 |
| 5 | 4134 | 6900 | 9500 | 11,700 |
| 6 | 3750 | 5416 | 7188 | 8306 |
| 7 | 2100 | 4630 | 6430 | 8008 |
| 8 | 2100 | 4850 | 6200 | 7860 |
| 9 | 3031 | 4513 | 6133 | 7945 |
| 10 | 2875 | 4081 | 7974 | 10,201 |
| 11 | 1217 | 3019 | 6195 | 7856 |
| 12 | 740 | 1568 | 5898 | 7790 |
| 13 | 900 | 2301 | 5331 | 7846 |
| 14 | 1190 | 2678 | 4711 | 6340 |
| 15 | 2427 | 6166 | 8603 | 11,543 |
| 16 | 795 | 2497 | 3964 | 6273 |

As shown in Table 3, cements and concretes of the present invention may yield a range of early strengths within 2-4 hours of casting, as well as providing a 28 day compressive strength equal to or greater than premium high strength Portland cement concrete products currently available.

The cement and concrete compositions of the present invention yield 4-hour compressive strengths ranging from 740 to 4,134 psi, 24-hour strengths ranging from 1,568 to 6,900 psi, 7-day strengths ranging from 3,964 to 9,500 psi, and 28-day strengths ranging from 6,273 to 11,700 psi. These results demonstrate the broad range of formulation flexibility available within the scope of the invention, spanning zero-slump dry-cast mixes (Sample 15, 0-inch spread) to highly fluid self-consolidating concrete (Samples 5 and 11, 30-inch spread), with fly ash comprising 77 to 94% of the cementitious fraction across all samples.

As shown in Table 2, typical concrete set times may range from 15 to 200 minutes. Typical working times (pot life) may range from 10 to 120 minutes. Exemplary strength properties may include: strength range (calculated from the addition of water/initiation of mixing): high early-ultrafast set time: (15 minutes), 2000 psi in 30 minutes; 5000 psi in 2 hours from set time; 12,000 psi ultimate-fast set: (1-2 hours); 2000-3000 psi in 2 hours from set time; and 8000-12,000 psi ultimate-slow set: (2-4 hours). 1000 psi in 2 hours from set time, 2000 psi in 24 hours from set time, 7000 psi ultimate. Working times ranged from 15 to 90 minutes and set times from 25 to 184 minutes, confirming the tunability of fresh concrete properties through retarder selection and dosage. All 16 samples achieved 28-day compressive strengths of 6,273 psi or greater, meeting or exceeding the threshold for high-strength concrete, while being produced with fly ash content of 77-94% of the cementitious fraction and without Portland cement clinker or alkali metal activators.

The product has been designed to minimize production costs, as only 10-20% of the total product requires dry-blending, with the bulk of the product industrial fly ash, able to be shipped directly from the coal-fired boiler to the final customer—the concrete precast or ready-mix plant without the additional cost/time/labor required to blend the product. Also, since only 10-20% of the product requires pre-blending, the energy costs for the entire process are reduced even further, lending to the lower carbon footprint.

In certain embodiments, CSA, GGBFS and quicklime may be used as minor additives, e.g., keeping the CSA or GGBFS to less than 8 weight percent of the total cement chemistry and the lime to less than 4 weight percent of the total cement chemistry. A crystal structure may be produced in which a high-early strengthening phase (Ettringite) is dispersed throughout a CSH (calcium-silica-hydrate) paste, and may act as a high-strength crystalline micro-fiber adding early strength and toughness to the cement.

The present invention may allow the use of low carbon waste streams to be the predominate constituent of the cement, providing very low CO₂ footprint.

Furthermore, by allowing the combination of the waste stream, e.g., Class C ash, CSA, and quicklime to form calcium hydroxide when mixed with water, the need for expensive and difficult to handle activators such as manufactured calcium hydroxide, potassium hydroxide, or silicate salts (sodium silicate) may be avoided. In addition to these common activators being costly, they are also very hydroscopic, which makes blending them difficult. Moreover, they are manufactured in form factors that do not allow for uniform blending, which would require them to be added separately to a dry blend product.

The present invention provides the ability to combine very high percentages of fly ash with very low levels of non-Portland cement activators and catalysts to produce a repeatable, well controlled, yet high-early strength cement and concrete. From a crystallographic standpoint, the reactions being driven in this system produce a unique blend of calcium silica hydrate (CSH) structure together with a well distributed discontinuous network of ettringite in the matrix. It is well know that in Portland cement systems, this structure is desirable to produce a more stable, higher-strength Portland cement. However, in this system a similar CSH/Ettringite structure is achieve without the need for the more environmentally damaging Portland cement.

A unique feature of the new hydraulic cement over existing products is its deconstructed mode which aids in reducing its carbon footprint. Since blended formulas consist mostly of fly ash, the ash may be shipped directly to the end user from its nearest fly ash source (power plant or depot). The remaining additive components (5-20%) may be shipped to a regional blending facility, blended and packaged, and then shipped directly to the end user. The totality of the dry cement may not be blended until it is mixed proportionally in a wet mixing device (drum mixer, plan mixer, volumetric mixer, etc.) to produce its final form of mortar or concrete. This approach reduces the energy (carbon footprint) and cost of blending the cement by as much as 90%, and also reduces the transportation (energy) costs by as much as 80%. These “logistical factors” are a significant contribution to the overall GWP reduction for this cement.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. A hydraulic cement composition comprising:
(a) from 50 to 99 weight percent fly ash comprising at least 50 weight percent Class C fly ash;
(b) from 0.1 to 40 weight percent of an activator comprising calcium sulfoaluminate cement, calcium aluminate cement, ground granulated blast furnace slag, anhydrite, ye′elimite, or a combination thereof; and
(c) from 0.05 to 20 weight percent of a catalyst comprising calcium oxide, lime kiln dust, dolomitic lime, calcium hydroxide, or a combination thereof.

2. The hydraulic cement composition of claim 1, wherein the composition is substantially free of Portland cement, alkali metal hydroxides, and alkali metal silicates.

3. The hydraulic cement composition of claim 1, wherein the fly ash is present in an amount of from 70 to 97 weight percent.

4. The hydraulic cement composition of claim 1, wherein the fly ash comprises from 70 to 100 weight percent Class C fly ash.

5. The hydraulic cement composition of claim 1, wherein the Class C fly ash has a calcium oxide content of from 15 to 40 weight percent, a sulfate content of from 1 to 10 weight percent, and a loss on ignition of from 0.5 to 15 weight percent.

6. The hydraulic cement composition of claim 1, wherein the activator comprises calcium sulfoaluminate cement in an amount of from 1 to 15 weight percent.

7. The hydraulic cement composition of claim 6, wherein the calcium sulfoaluminate cement is present in an amount of from 3 to 10 weight percent.

8. The hydraulic cement composition of claim 1, wherein the catalyst comprises calcium oxide in an amount of from 0.5 to 10 weight percent.

9. The hydraulic cement composition of claim 8, wherein the calcium oxide is present in an amount of from 1 to 6 weight percent.

10. The hydraulic cement composition of claim 1, further comprising from 0.005 to 2 weight percent of a retarder.

11. The hydraulic cement composition of claim 1, further comprising a retarder comprising citric acid, salts of citric acid, boric acid, salts of boric acid, calcium sulfate, tartaric acid, salts of tartaric acid, gluconic acid, salts of gluconic acid, or a combination thereof.

12. The hydraulic cement composition of claim 1, further comprising from 0.01 to 10 weight percent of a densifier.

13. The hydraulic cement composition of claim 1, further comprising a densifier comprising silica fume, metakaolin, ultrafine fly ash, nano-silica, colloidal silica, lithium silicate, or a combination thereof.

14. The hydraulic cement composition of claim 1, wherein the hydraulic cement composition further comprises aggregate.

15. The hydraulic cement composition of claim 14, wherein the hydraulic cement composition comprises from 10 to 80 weight percent of the fly ash, activator, and catalyst, and from 20 to 90 weight percent of the aggregate.

16. The hydraulic cement composition of claim 14, wherein the hydraulic cement composition comprises from 20 to 70 weight percent of the fly ash, activator, and catalyst, and from 30 to 80 weight percent of the aggregate.

17. A curable concrete composition comprising:
(a) the hydraulic cement composition of claim 1;
(b) aggregate; and
(c) water.

18. The curable concrete composition of claim 17, wherein the hydraulic cement composition comprises from 5 to 60 weight percent calculated from a dry weight of the concrete composition after curing, and the aggregate comprises from 30 to 80 weight percent calculated from the dry weight of the concrete composition after curing.

19. The curable concrete composition of claim 18, having a water-to-cement weight ratio of from 0.20 to 0.50.

20. The curable concrete composition of claim 17, wherein the cured concrete achieves a compressive strength of at least 800 psi within 90 minutes of mixing the hydraulic cement composition and the aggregate with the water.

21. The curable concrete composition of claim 17, having a slump flow of at least 24 inches measured according to ASTM C1611.

22. A composition comprising an activator and catalyst for use in hydraulic cement, the composition comprising:
(a) from 10 to 90 weight percent of an activator comprising calcium sulfoaluminate cement, calcium aluminate cement, ground granulated blast furnace slag, anhydrite, ye′elimite, or a combination thereof; and
(b) from 5 to 80 weight percent of a catalyst comprising calcium oxide, lime kiln dust, dolomitic lime, calcium hydroxide, or a combination thereof,
wherein the composition is substantially free of Portland cement, alkali metal hydroxides, and alkali metal silicates.

23. The composition of claim 22, wherein the activator comprises from 20 to 80 weight percent, and the catalyst comprises from 10 to 60 weight percent.

24. A method of producing a low carbon hydraulic cement comprising fly ash comprising at least 50 weight percent Class C fly ash, an activator comprising calcium sulfoaluminate cement, calcium aluminate cement, ground granulated blast furnace slag, anhydrite, ye′elimite or a combination thereof, and a catalyst comprising calcium oxide, lime kiln dust, dolomitic lime, calcium hydroxide or a combination thereof,
blending the fly ash, activator, and catalyst to form a dry hydraulic cement composition, wherein the dry hydraulic cement is substantially free of Portland cement clinker, alkali metal hydroxides, and alkali metal silicates.

25. The method of claim 24, wherein the fly ash is provided separately to a user, and the activator and catalyst are blended together and provided separately to the end user for final blending with the fly ash by the user.

26. A method of producing concrete with an accelerated production cycle, the method comprising:
(a) mixing a hydraulic cement composition of claim 1 with aggregate and water to form a concrete mixture;
(b) placing the concrete mixture in a mold or form;
(c) allowing the concrete to set and cure to a compressive strength of at least 800 psi; and
(d) removing the concrete from the mold or form,
wherein steps (a) through (d) are completed in 120 minutes or less from the time of initial mixing.

27. The method of claim 26, wherein the concrete mixture has a slump flow of at least 24 inches.

28. The method of claim 26, wherein steps (b) through (e) are completed in 90 minutes or less.

29. A hardened cement paste produced by hydration of the hydraulic cement composition of claim 1, wherein the hardened cement paste comprises a microstructure comprising a continuous matrix of calcium silicate hydrate (C-S-H) gel with dispersed ettringite crystals.
